(19) United States
(12) Patent Application Publication
(10) Pub. No.: US 2010/0061343 A1
(43) Pub. Date: Mar. 11, 2010

(54) Scenario Based Measurement Type Selection

(75) Inventors: Muhammad Kazmi, Bromma (SE); Zhang Zhang, Beijing (CN)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/515,623

(22) PCT Filed: Nov. 20, 2006
(86) PCT No.: PCT/SE06/50492

§ 371 Date: May 20, 2009

(51) Int. Cl. H04W 4/00

(52) U.S. Cl. 370/332

(57) ABSTRACT

Techniques are provided to obviate unnecessarily requesting that different types of measurements are simultaneously made by a user equipment unit (30) in anticipation of a handover in a radio access network. In accordance with one aspect of the technology, in preparing a measurement request for a user equipment unit (served by a currently utilized cell) to measure on signal(s) transmitted from other cell(s) for evaluating handover potential; a network node uses at least one deployment parameter for selecting between three measurement alternatives for the measurement request. In a generic embodiment, the three measurement alternatives are: (1) performing only a first type of measurement(s); (2) performing only a second type of measurement(s): and (3) simultaneously performing both the first type and the second type of measurement(s). In a more specific example embodiment, the three measurement alternatives are: (1) performing only an inter-frequency measurement(s): (2) performing only an inter-radio access technology measurement(s); and (3) simultaneously performing both inter-frequency measurement(s) and inter-radio access technology measurement(s).

### BACKGROUND

I. Technical Field

This invention relates to a telecommunications, and particularly to a code division multiple access (CDMA) communication system which uses at least one carrier frequency.

II. Related Art and Other Considerations

In a typical cellular radio system, wireless user equipment units (UEs) communicate via a radio access network (RAN) to one or more core networks. The user equipment units (UEs) can be mobile stations such as mobile telephones (“cellular” telephones) and laptops with mobile termination, and thus can be, for example, portable, pocket, hand-held, computer-included, or car-mounted mobile devices which communicate voice and/or data with radio access network. Alternatively, the wireless user equipment units can be fixed wireless devices, e.g., fixed cellular devices/terminals which are part of a wireless local loop or the like.

The radio access network (RAN) covers a geographical area which is divided into cell areas, with each cell area being served by a base station. A cell is a geographical area where radio coverage is provided by the radio base station equipment at a base station site. Each cell is identified by a unique identity, which is broadcasted in the cell. The base stations communicate over the air interface with the user equipment units (UE) within range of the base stations. In the radio access network, several base stations are typically connected (e.g., by landlines or microwave) to a radio network controller (RNC). The radio network controller, also sometimes termed a base station controller (BSC), supervises and coordinates various activities of the plural base stations connected thereto. The radio network controllers are typically connected to one or more core networks. The core network has two service domains, with an RNC having an interface to both of these domains.

A radio access network (RAN) operates in accordance with a particular radio access technology (RAT). One example of a radio access network is the Universal Mobile Telecommunications (UMTS) Terrestrial Radio Access Network (UTRAN) which, suitably enough, utilizes UMTS radio access technology. The UMTS is a third generation system which in some respects builds upon an earlier radio access technology known as Global System for Mobile communications (GSM) developed in Europe. UTRAN is essentially a radio access network providing wideband code division multiple access (WCDMA) to user equipment units (UEs). The Third Generation Partnership Project (3GPP) has undertaken to evolve further the UTRAN and GSM-based radio access network technologies.

As those skilled in the art appreciate, in WCDMA technology a common frequency band allows simultaneous communication between plural user equipment units (UEs) and a base station. Signals occupying the common frequency band are discriminated at the receiving station through spread spectrum CDMA waveform properties based on the use of a high speed, pseudo-noise (PN) code. These high speed PN codes are used to modulate signals transmitted from the base stations and the user equipment units (UEs). Transmitter stations using different PN codes (or a PN code offset in time) produce signals that can be separately demodulated at a receiving station. The high speed PN modulation also allows the receiving station to advantageously generate a received signal from a single transmitting station by combining several distinct propagation paths of the transmitted signal. In CDMA, therefore, a user equipment unit (UE) need not switch frequency when handover of a connection is made from one cell to another. As a result, a destination cell can support a connection to a user equipment unit (UE) at the same time the origination cell continues to serve the connection. Since the user equipment unit (UE) is always communicating through at least one cell during handover, there is no disruption to the call. Hence, the term “soft handover.” In contrast to hard handover, soft handover is a “make-before-break” switching operation.

Other types of telecommunications systems which encompass radio access networks and thus other types of radio access technologies include the following: Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; and the code division multiple access (CDMA) system described in EIA/TIA IS-95.

An inter-radio access technology handover (IRAT HO) is the handover between two radio access network (RAN) systems using different radio access technologies. An IRAT HO provides the ability to maintain service continuation on dedicated channels (DCH) for circuit switched services, despite the fact that a user equipment unit may leave an area served by a first radio access technology.

Inter-frequency handover (IFHO) is the hard handover between different carriers. e.g., carriers of different frequency. An IFHO provides the ability to maintain connection towards a user equipment unit (UE) within the same radio access network (RAN) when the user equipment unit is moving between different frequencies while the user equipment unit is in the CELL_DCH state.

To perform an inter-radio access technology (IRAT) or inter-frequency (IFHO) handover, the user equipment unit (UE) needs to measure the quality of the currently utilized cell(s) as well as the quality of other system(s) (e.g., to determine if an IRAT handover should occur) or other frequency(ies) (e.g., to determine if an IF handover should occur). The measurement quantity(ies) may include signal strength, signal to noise/interference ratio, bit error rate, or the like. Such measurements typically occur by measuring or determining the measurement quantity(ies) with respect to a certain signal or channel broadcasted by a group of base stations of cells having another radio access technology or frequency. To limit signaling overhead and processing load, the measurements are typically not performed all the time, but periodically activated or event triggered. For periodical measurement, the measurements are performed at a certain time interval. For event triggered measurement, the measurements are performed when certain condition is fulfilled, e.g. the measurement quantity(ies) with respect to a certain signal or channel broadcasted by the base station of the cell that the user equipment unit (UE) is currently camped on is(are) worse than the pre-defined quality threshold(s). Moreover, in CDMA FDD mode a compressed mode (CPM) is needed to create gaps for the inter-radio access technology (IRAT) and/or inter-frequency (IF) measurement since the CDMA transmission is time continuous. Measurements preparatory to IRAT handover and IF handover are described, e.g., in U.S. Pat. No. 6,845,238 to Müller, entitled “INTER-FREQUENCY MEASUREMENT AND HANDOVER FOR WIRELESS COMMUNICATIONS”, which is incorporated herein by reference in its entirety.

In US Patent Publication US/2005/0277416 to Tolli et al. compressed mode measurements are ostensibly kept to a minimum and are performed according to a priority table. Tolli addresses a situation in which simultaneously making inter-frequency (IF) measurements and inter-system (IS) measurements might not be possible. Tolli makes a decision whether to perform IF or IS measurements prior to starting any measurement. A measurement table of US/2005/0277416 provides a prioritized indication of the order in which measurements should be performed by a mobile station that wishes to handover to another cell of a system/frequency.

In fact, in early telecommunications systems measurements for IFHO and IRAT HO were performed separately since, e.g., neither the radio access networks nor the user equipment units supported simultaneous or parallel measurements for IFHO and IRAT HO. However, in a more recent 3GPP release (Release 6), two features have been added that ensure that user equipment units have the capability of the combined IF and IRAT measurement. A first such feature is a required RRM test (see, e.g., 3rd Generation Partnership Project, Technical Specification Group Radio Access Network, Requirements for support of radio resource management (FDD), TS25.133 V6.12.0), incorporated by reference herein in its entirety). A second such feature is a protocol test (see, e.g., 3rd Generation Partnership Project, Technical Specification Group Radio Access Network, User Equipment (UE) conformance specification; Part 1: Protocol conformance specification, TS34.123-1, incorporated by reference herein in its entirety).

Furthermore the existing physical layer compressed mode requirements [as set forth, for example, in 3rd Generation Partnership Project. Technical Specification Group Radio Access Network, User Equipment (UE) radio transmission and reception (FDD), TS25.101 V6.10.0, incorporated by reference herein in its entirety] have been redefined using a denser pattern and in more challenging environment (e.g. higher speed) to ensure appropriate physical layer operations for user equipment units (such as demodulation and power control) in case of frequent compressed mode gaps.

Advantageously, a combined inter-RAT and inter-frequency measurement can make sure that a user equipment unit is kept in CDMA as long as possible by prioritizing IFHO, and that handover to another RAN (e.g., a non-CDMA RAN) only occurs when the CDMA quality fails on all CDMA frequencies.

However, despite the advantages of combined inter-RAT and inter-frequency measurements, always or automatically starting a combined inter-RAT and inter-frequency measurement for a measurement request can be inefficient and unnecessary. A combined inter-RAT and inter-frequency measurement can, in at least some situations, involve a longer measurement reporting delay, higher signaling overhead, and higher processing load.

Further, a too long measurement delay may also lead to a situation in which the combined measurement is no longer reliable. For example, the IF or IRAT neighbor's quality changes, but the measurement report is not updated timely for evaluation of handover criteria, the handover evaluation will not be based on current enough information therefore may be inaccurate.

What is needed, therefore, and an object of the present technology, are one or more of techniques, methods, apparatus, and systems for determining whether to perform a combined inter-radio access technology measurement and inter-frequency measurement, or instead to perform only one type of measurement (inter-radio access technology measurement or inter-frequency measurement), and (if so), which type of measurement to perform.

One example advantage and feature of at least some embodiments of the present technology is characterization of a deployment scenario by a set of deployment/scenario parameters.

Another advantage and feature of at least some embodiments of the present technology is provision of a set of measurement rules based on the deployment parameters.

### BRIEF SUMMARY

Techniques are provided to obviate unnecessarily requesting that different types of measurements be simultaneous made by a user equipment unit in anticipation of a handover in a radio access network. In accordance with one aspect of the technology, in preparing a measurement request for a user equipment unit (served by a currently utilized cell) to measure on signal(s) transmitted from other cell(s) for evaluating handover potential; a network node uses at least one deployment parameter for selecting between three measurement alternatives for the measurement request. In a generic embodiment, the three measurement alternatives are: (1) performing only a first type of measurement(s); (2) performing only a second type of measurement(s); and (3) simultaneously performing both the first type and the second type of measurement(s). In a more specific example embodiment, the three measurement alternatives are: (1) performing only an inter-frequency measurement(s): (2) performing only an inter-radio access technology measurement(s); and (3) simultaneously performing both inter-frequency measurement(s) and inter-radio access technology measurement(s).

In an example embodiment, the network node uses a set of deployment parameters for selecting between the three measurement alternatives for the measurement request. The set of deployment parameters comprise at least one of the following: cell topology, cell size, cell position, and frequency layer. Preferably but not necessarily the set of deployment parameters comprise all of cell topology, cell size, cell position, and frequency layer. In addition, the set of deployment parameters can also include traffic load. While some of the deployment parameters of the set (such as cell size, cell position, and frequency layer) serve to characterize the currently utilized cell, others of the deployment parameters of the set (such as traffic load and cell topology) deal with both the currently utilized cell and target cell(S) of another system/frequency.

In an example embodiment, the network node uses the set of deployment parameters to classify a particular scenario, and then selects between the three measurement alternatives in accordance with the particular scenario.

In one of its aspects, the technology involves a method of operating a radio access network comprising a network node and a user equipment unit served by a currently utilized cell. The method comprises the node providing a measurement request for the user equipment unit to measure on signal(s) transmitted from other cell(s) for evaluating handover potential; and the node using at least one deployment parameter for selecting between three measurement alternatives. In a generic embodiment, the three measurement alternatives are: (1) performing only a first type of measurement(s); (2) performing only a second type of measurement(s); and (3) simultaneously performing both the first type and the second type of measurement(s).

In one of its aspects, the technology involves a node of a radio access network which provides a measurement request for a user equipment unit served by a currently utilized cell to measure on signal(s) transmitted from other cell(s) for evaluating handover potential. The node is arranged to use at least one deployment parameter characterizing the currently utilized cell to select between three measurement alternatives for the measurement request. In a generic embodiment, the three measurement alternatives are: (1) performing only a first type of measurement(s); (2) performing only a second type of measurement(s); and (3) simultaneously performing both the first type and the second type of measurement(s).

In another of its aspects, the technology involves a radio access network comprising a node as summarized above and a user equipment unit served by a currently utilized cell.

In accordance with another aspect of the technology, a node of a radio access network uses a deployment parameter to specify in the measurement request a type of cell upon which to measure. The deployment parameter comprises at least one of the following: cell topology, cell size, cell position, and frequency layer. For example, in an example implementation the node uses a set of deployment parameters to specify a type of cell upon which to measure, with the set of deployment parameters comprising cell topology, cell size, cell position, and frequency layer. The type of cell upon which to measure is specified to be either: (1) only a cell(s) having a different frequency than the currently utilized cell; (2) only a cell(s) of a different radio access technology than the currently utilized cell; and (3) both cell(s) having a different frequency than the currently utilized cell and cell(s) of a different radio access technology than the currently utilized cell. In other aspects the technology also encompasses a radio access network and method of operating a radio access network in accordance with the foregoing.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic view of an example embodiment of mobile communications system in which the present technology may be advantageously employed.

FIG. 2 is a simplified function block diagram of a portion of a UMTS Terrestrial Radio Access Network, including a user equipment unit (UE) station; a radio network controller: and a base station.

FIG. 3A-FIG. 3C are diagrammatic views showing differing situations of cell measurement corresponding to three differing measurement alternatives.

FIG. 4 is a diagrammatic view illustrating how a cell position may be defined or classified as either a border cell, center cell, or inner cell.

FIG. 5A is a diagrammatic view illustrating measurement type selection using measurement rules; FIG. 5B is a flow chart showing basic example steps involved in a procedures of using measurement rules such as those of FIG. 5A.

FIG. 6 is a diagrammatic view illustrating measurement type selection using simplified measurement rules.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

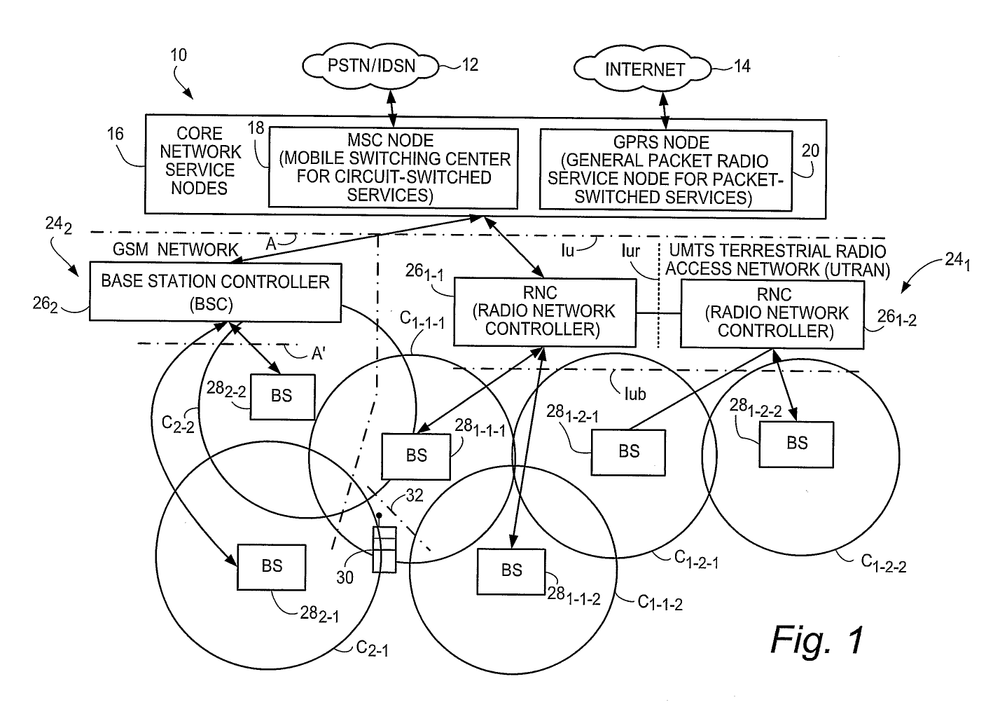

The present invention is described in the non-limiting, example context of a telecommunications system 10 shown in FIG. 1. A representative, connection-oriented, external core network, shown as a cloud 12 may be for example the Public Switched Telephone Network (PSTN) and/or the Integrated Services Digital Network (ISDN). A representative, connectionless-oriented external core network shown as a cloud 14, may be for example the Internet. Both core networks are coupled to corresponding service nodes 16. The PSTN/ISDN connection-oriented network 12 is connected to a connection-oriented service node shown as a Mobile Switching Center (MSC) node 18 that provides circuit-switched services. The Internet connectionless-oriented network 14 is connected to a General Packet Radio Service (GPRS) node 20 tailored to provide packet-switched type services which is sometimes referred to as the serving GPRS service node (SGSN).

FIG. 1 further shows two distinct radio access networks (e.g., RANs), in particular, radio access network (RAN) 24₁ and radio access network (RAN) 24₂. In the particular example embodiment, radio access network 24₁ is a UMTS Terrestrial Radio Access Network (UTRAN) and radio access network 24₂ is a GSM (Global System for Mobile communications) network. The radio access network 24₁ and radio access network 24₂ are not limited to the illustrated radio access technology types, but instead can be any two radio access networks having differing radio access technologies (RATs), e.g., UMTS Terrestrial Radio Access Network (UTRAN), Global System for Mobile communications (GSM); Advance Mobile Phone Service (AMPS) system: the Narrowband AMPS system (NAMPS): the Total Access Communications System (TACS): the Personal Digital Cellular (PDC) system; the United States Digital Cellular (USDC) system; and the code division multiple access (CDMA) system described in EIA/TIA IS-95.

The UMTS Terrestrial Radio Access Network (UTRAN) 24₁ connects to each of the core network service nodes 18 and 20 over a radio access network (RAN) interface referred to as the Iu interface. UTRAN 24₁ includes one or more radio network controllers (RNCs) 26₁. Each RNC 26₁ is connected to one or more base stations (BS) 28₁ and likely to one or more RNCs in the UTRAN 24₁. For sake of simplicity, the radio access network 24₁ of FIG. 1 is shown with only two RNC nodes 26₁, in particular RNC nodes 26₁₋₁ and 26₁₋₂. The base stations 28₁ communicate with mobile station(s) or user equipment unit(s) 30 over a radio or air interface 32. Again for sake of simplicity, only four base station nodes 28₁ are illustrated in FIG. 1, in particular base station 28₁₋₁₋₁ and base station 28₁₋₁₋₂ both served by RNC₁₋₁, and base station 28₁₋₂₋₁ and base station 28₁₋₂₋₂ served by RNC₁₋₂. Base station 28₁₋₁₋₁ serves cell C₁₋₁₋₁, base station 28₁₋₁₋₂ serves cell C₁₋₁₋₂, and so forth.

It will be appreciated that a different number of base stations than that shown in FIG. 1 can be served by each radio network controller node 26₁, and that RNCs 26₁ need not serve the same number of base stations. Moreover, an RNC can be connected over an Iur interface to one or more other RNCs in radio access network 24₁, one such instance of an Iur interface being shown in FIG. 1. The radio network controller nodes (RNC) 26₁ communicate over an interface Iub with the radio base stations 28₁. Further, those skilled in the art will also appreciate that a base station is sometimes also referred to in the art as a radio base station, a node B, or B-node. Each of the radio interface 32, the Iu interface, the Iur interface, and the Iub interface are shown by dash-dotted lines in FIG. 1.

In UMTS Terrestrial Radio Access Network (UTRAN) 24₁, radio access is based upon wideband. Code Division Multiple Access (WCDMA) with individual radio channels allocated using CDMA spreading codes. WCDMA provides wide bandwidth for multimedia services and other high transmission rate demands as well as robust features like diversity handoff and RAKE receivers to ensure high quality. Each user mobile station or equipment unit (UE) 30 is assigned its own scrambling code in order for a base station 28₁ to identify transmissions from that particular user equipment unit (UE) (i.e., reverse link) as well as for the user equipment unit (UE) to identify transmissions from the base station intended for that user equipment unit (UE) (i.e., forward link) from all of the other transmissions and noise present in the same area. Different scrambling codes may be used for the reverse link and the forward link of the same user equipment unit (UE).

The example GSM (Global System for Mobile communications) network 24₂ of radio access network 24₂ is connected to MSC node 18 of core network 16 over an interface A. The radio access network 24₂ includes a base station subsystem (BSS). The base station subsystem (BSS) comprises at least one (and preferably plural) base station controllers (BSC) 26₂, with each base station controller serving at least one (and preferably plural) base stations (BS) 28₂. The base station controller (BSC) 26₂ is connected to its radio base stations 28₂ over interface A′. Base station 28₂₋₁ serves cell C₂₋₁, base station 28₂₋₂ serves cell C₂₋₂, and so forth. In like manner as already explained, the number and connections of base station controllers (BSC) 26₂, base stations 28₂, cells C₂, and the like shown in FIG. 1 are merely for sake of example.

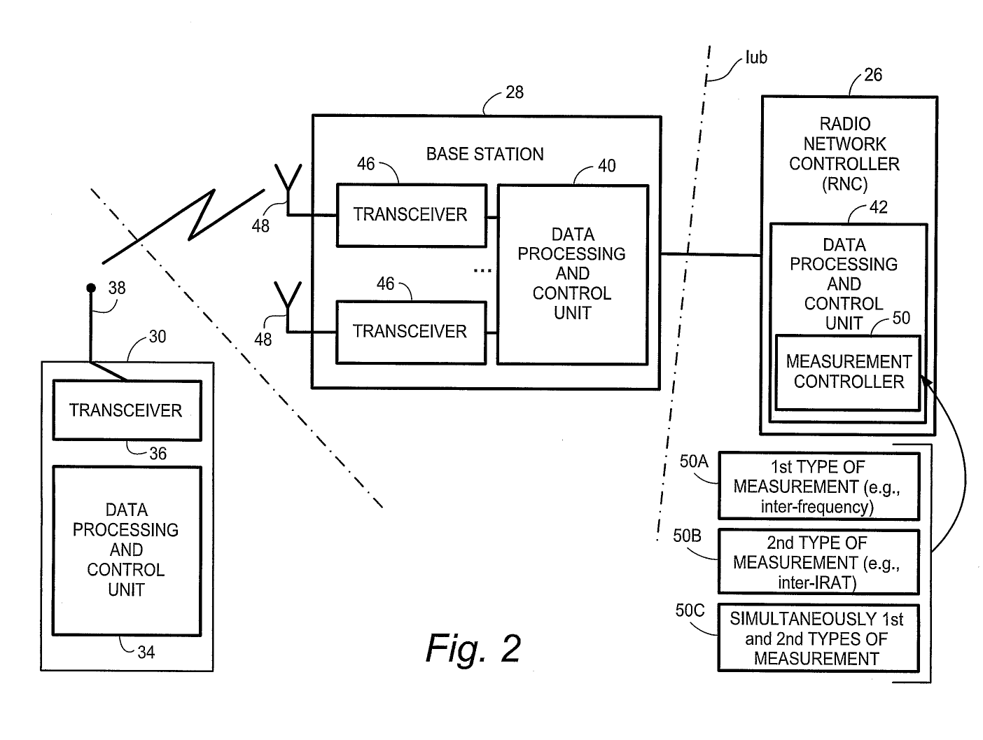

FIG. 2 shows selected general aspects of user equipment unit (UE) 30 and illustrative nodes such as radio network controller 26₁ and base station 28₁. The user equipment unit (UE) 30 shown in FIG. 2 includes a data processing and control unit 34 for controlling various operations required by the user equipment unit (UE). The UE's data processing and control unit 34 provides control signals as well as data to a radio transceiver 36 connected to an antenna 38.

The example radio network controller 26₁ and base station 28₁ as shown in FIG. 2 are radio network nodes that each include a corresponding data processing and control unit 40 and 42, respectively, for performing numerous radio and data processing operations required to conduct communications between the RNC 26₁ and the user equipment units (UEs) 30. Part of the equipment controlled by the base station data processing and control unit 40 includes plural radio transceivers 46 connected to one or more antennas 48.

User equipment units (UEs) may be employed to provide measurement reports so that the UTRAN receives real-time knowledge of the network conditions based on one or more parameters measured by the user equipment units (UEs). It is preferable to get the relevant information in UTRAN with as little signaling as possible from each user equipment unit (UE). The sending of a measurement report may be event triggered, as described (for example) in U.S. Pat. No. 6,445,917, entitled “MOBILE STATION MEASUREMENTS WITH EVENT-BASED REPORTING” (incorporated herein by reference). Consequently, real-time knowledge of network conditions can be selectively conveyed at relevant moments so the UTRAN can effectively respond without delay and without excessive signaling overhead. An adaptive set of predetermined “events” and/or predetermined “conditions” may be defined that trigger measurement reports to be sent from the user equipment unit (UE). Once the report is received, the UTRAN may then analyze the reported information and perform, if necessary, responsive or other desirable operations like handover, power control, operations and maintenance, network optimization, and other procedures.

As mentioned above, capabilities now exist, at least in some systems, to measure simultaneously (1) the quality of other system(s) (e.g., to determine if an IRAT handover should occur) and (2) the quality of other frequency(ies) (e.g., to determine if an IF handover should occur). However, providing simultaneous IF and IRAT measurements requires considerable signaling and processing overhead.

Accordingly, one aspect of the present technology is provision, at a network node of a radio access network, of a capability such as a measurement controller 50 which prepares and issues a measurement request for a user equipment unit (served by a currently utilized cell) to measure on signal(s) transmitted from other cell(s) for evaluating handover potential. In one example, the measurement controller 50 uses at least one deployment parameter for selecting between three measurement alternatives 52A, 52B, and 52C for the measurement request.

In a generic example embodiment, the three measurement alternatives are: (1) performing only a first type of measurement(s) (alternative 50A in FIG. 2); (2) performing only a second type of measurement(s) (alternative 50B in FIGS. 2); and (3) simultaneously performing both the first type and the second type of measurement(s) (alternative 50C in FIG. 2).

In a more specific example embodiment, the three measurement alternatives are: (1) performing only an inter-frequency measurement(s) (alternative 50A in FIG. 2); (2) performing only an inter-radio access technology measurement(s) (alternative 50B in FIG. 2); and (3) simultaneously performing both inter-frequency measurement(s) and inter-radio access technology measurement(s) (alternative 50C in FIG. 2).

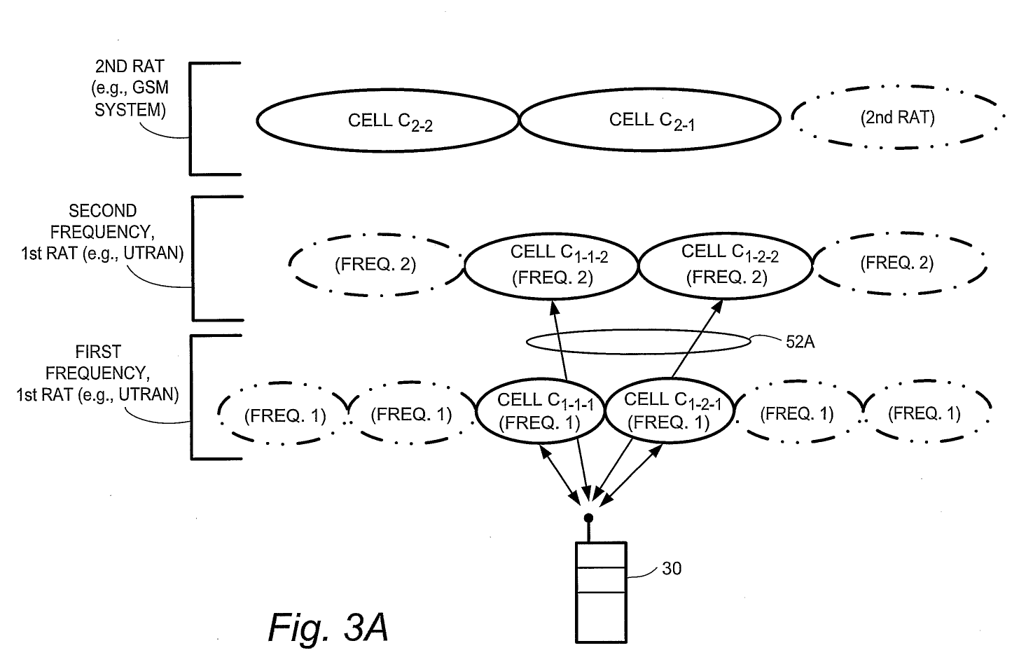

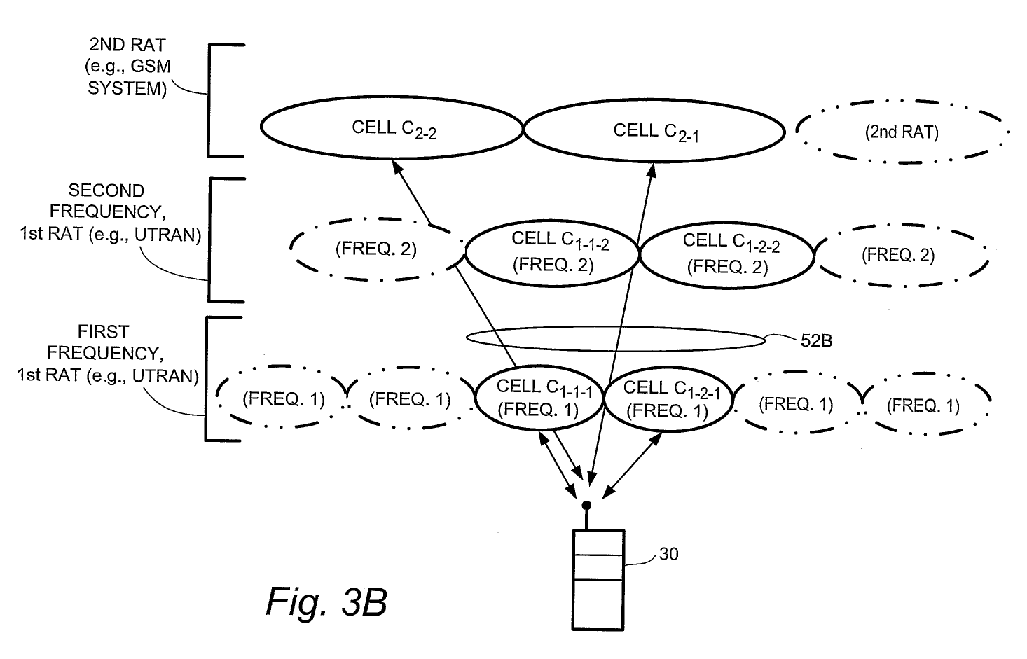

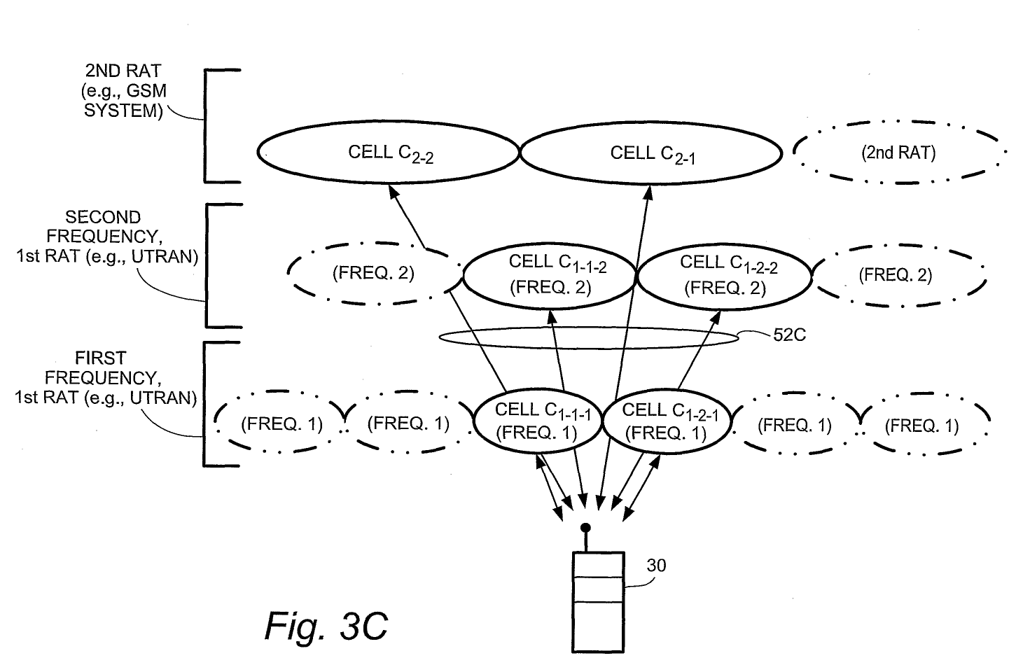

The three measurement alternatives 52A, 52B, and 52C of the specific example embodiment discussed above are illustrated in FIG. 3A-FIG. 3C, respectively. FIG. 3A-FIG. 3C assume a network configuration similar to that of FIG. 1, and further assume that cell C₁₋₁₋₁ and cell C₁₋₂₋₁ (served by radio base stations 28₁₋₁₋₁ and 28₁₋₂₋₁, respectively, of radio access network 24₁) operate at a first frequency (Freq. 1); that cell C₁₋₁₋₂ and cell C₁₋₂₋₂ (served by radio base stations 28₁₋₁₋₂ and 28₁₋₂₋₂, respectively, of radio access network 24₁) operate at a second frequency (Freq. 2): and that cell C₂₋₁ and cell C₂₋₂ (served by radio base stations 28₂₋₁ and 28₂₋₂, respectively) are of a different radio access technology (e.g., cell C₂₋₁ and cell C₂₋₂ belong to radio access network 24₂ rather than radio access network 24₁).

In context of the specific example implementation of FIG. 1 (in which radio access network 24₁ is a UTRAN network and radio access network 24₂ is a GSM network), FIG. 3A illustrates a situation in which measurement controller 50 determines that a user equipment unit 30 should perform inter-frequency measurement(s) (alternative 52A in FIG. 2). In other words, in addition to possibly measuring on one or more cells of the first frequency (Freq. 1), e.g., cell C₁₋₁₋₁ and cell C₁₋₂₋₁, the measurement controller 50 directs that the user equipment unit 30 should also measure on one or more of cell C₁₋₁₋₂ and cell C₁₋₂₋₂ which have the second frequency (Freq. 2).

FIG. 3B illustrates a situation in which measurement controller 50 determines that a user equipment unit 30 should perform inter-IRAT measurement(s) (alternative 52B in FIG. 2). In other words, in addition to possibly measuring on one or more cells of the first radio access network 24₁, e.g., cell C₁₋₁₋₁ and cell C₁₋₂₋₁, the measurement controller 50 directs that the user equipment unit 30 should also measure on one or more of cell C₂₋₁ and cell C₂₋₂ which belong to another radio access technology. e.g., the technology of radio access network 24₂.

FIG. 3C illustrates a situation in which measurement controller 50 determines that a user equipment unit 30 should perform both inter-frequency measurement(s) and inter-RAT measurement(s) (alternative 52C in FIG. 2). In other words, in addition to possibly measuring on one or more cells of the first frequency (Freq. 1) and radio access network 24₁, e.g., cell C₁₋₁₋₁ and cell C₁₋₂₋₁, the measurement controller 50 directs that the user equipment unit 30 should also measure on one or more of cell C₁₋₁₋₂ and cell C₁₋₂₋₂ which have the second frequency (Freq. 2) and one or more of cell C₂₋₁ and cell C₂₋₂ which belong to another radio access technology, e.g., the technology of radio access network 24₂.

Thus, measurement controller 50 accommodates different scenarios of operation. In some scenarios only inter-frequency handover (IFHO) is required (alternative 52A), whereas in some other scenarios only inter-radio access technology (IRAT) handovers are necessary (alternative 52B). Similarly there are some scenarios where both types of handover may be useful (alternative 52C). If one type of handover is not needed as determined by measurement controller 50, then the corresponding measurement is also not required, in which case signaling and processing overhead is advantageously reduced.

In a UTRAN radio access network such as radio access network 24₁, the measurement controller 50 can be located at a radio network controller node 26₁. Alternatively, the measurement controller 50 can be located at another network node, or a data base or service node accessible to a node of radio access network 24₁. Examples of such nodes are O&M system (operational and maintenance), propriety radio resource management) RRM server etc. Such nodes (O&M or RRM server) can be generally connected to the radio access network via a propriety (non-standardized) or quasi-standardized interface. Nodes other than radio network controller are feasible when handover selection is purely based on static parameters. The measurement controller 50 can be implemented as a processor using the broad definition of “processor” as previously provided.

In an example embodiment, the network node uses a set of deployment parameters for selecting between the three measurement alternatives 50A, 50B, and 50C for the measurement request. The set of deployment parameters comprise at least one of the following: cell topology, cell size, cell position, and frequency layer. Preferably but not necessarily the set of deployment parameters comprise all of cell topology, cell size, cell position, and frequency layer. In addition, traffic load may also be included in the set of deployment parameters. While some of the deployment parameters of the set (such as cell size, cell position, and frequency layer) serve to characterize the currently utilized cell, others of the deployment parameters of the set (such as traffic load and cell topology) deal with both the currently utilized cell and target cell(S) of another system/frequency.

Thus, a network deployment can be characterized by a set of parameters. Example deployment parameters are listed and described in Table 1

TABLE 1
EXAMPLE DEPLOYMENT PARAMETERS

Topology - Example and typical deployments are listed below:
macro island on one frequency (f1) and some
cells co-sited with another frequency (f2)
macro multi-carriers, covering the same area
hierarchical cell struture (HCS) (macro +
micro, macro + pico, etc.)
(macro) cell size - small, medium and large
Cell position - a 3G CDMA system may only cover a limited
area (island) in its early deploying period, and a cell may be
located at the island border, island center or somewhere
between:
Border cell: located at the island border and have
large coverage outside of the island
Center cell: located deep into the island and almost
all of its coverage is within the island
Inner cell: between the border and center cell and has
a little coverage outside of the island
Frequency layer
Traffic load

In an example embodiment, the measurement controller 50 uses the set of deployment parameters for classifying a particular scenario. That is, collectively plural parameters such as two or more of the deployment parameters listed in Table 1 specify a deployment scenario. For example, one possible scenario is, e.g. a WCDMA system having co-sited macro cell on three different carriers, the cell size being medium (on all carriers), the currently utilized cell being a center cell, the currently utilized cell belonging to frequency layer 1, with a high load on frequency 1 and a low load on the other frequencies.

The measurement controller 50 thus operates in accordance with measurement selection rules. The measurement controller 50 uses the set of deployment parameters which describe the scenario as an input to the measurement rule for selecting between the three measurement alternatives in accordance with the particular scenario. The output of the measurement rule is the preferred measurement alternative and the handover type for the specific deployment scenario.

The deployment parameters of topology, cell position, and frequency layer are static parameters which can be pre-determined in e.g. cell planning phase. The deployment parameter of cell size is semi-static parameter, e.g., cell size does not dynamically change but due to the irregular cell pattern the cell size may be small in one direction but large in another direction, and therefore it may be necessary to determine on-line the cell size according to the position of a user equipment unit (based on UE's measurement report). The deployment parameter of traffic load can be a dynamic or semi-static parameter which needs to be estimated on-line but can also be predicted from traffic statistic data (or use the average load over a certain time).

Table 2 through Table 4 provide criteria for classifying a cell according to deployment parameters. For example. Table 2 provides example criteria for classifying a cell as small, medium, or large in terms of received signal code power (RSCP), in dBm. Table 3 provides example criteria for classifying uplink (UL) cell load for a cell as either low, medium, or high. Table 3 evaluates cell load in terms of a fraction of users in transport format combination (TFC) limitation. Table 4 provides example criteria for classifying downlink (DL) cell load for a cell as either low, medium, or high. Table 4 evaluates cell load in terms of base station transmit power relative to maximum base station power.

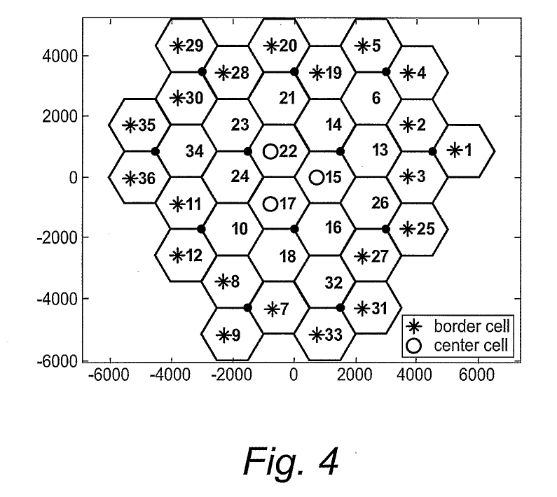

FIG. 4 illustrates how a cell position may be defined or classified as either a border cell or a center (e.g., central) cell. Cells in FIG. 4 which are border cells are denoted with an asterisk (*); cells in FIG. 4 which are center cells are denoted with a circle (O). Cells in FIG. 4 which are not marked as border cells or center cells are inner cells.

The example criteria of Table 2, Table 3, and Table 4, and the situation of FIG. 4, are merely example configurations. The person skilled in the art understands that other configurations (either the criteria or the thresholds, or both) may be adopted according to such considerations and factor as, e.g., an operator's requirement.

TABLE 2
Example configuration of cell size parameters
Cell size in terms of RSCP [dBm]

| Small | Medium | Large |
|---|---|---|
| <−97 | [−107 −97] | >−107 |

TABLE 3
Example configuration of UL cell load
UL Cell load in terms of fraction of users in TFC limitation [4]

| Low | Medium | High |
|---|---|---|
| <1% | [1% 5%] | >5% |

TABLE 4
Example configuration of DL cell load
DL Cell load in terms of RBS tx power relative to max RBS power

| Low | Medium | High |
|---|---|---|
| <40% | [40% 70%] | >70% |

In the ensuing description an example set of deployment parameters will be assumed to comprise the five deployment parameters listed above. However, the invention is not limited to the particularly described set of deployment parameters or any number of deployment parameters.

As mentioned above, a measurement rule contains the following elements:
Input: a set of scenario parameters which describe a deployment scenario
Output: (preferred) measurement and handover type for the specific deployment scenario

Table 5-7 show some examples of typical deployment scenarios (input of the measurement rules) where different measurement types (output of the measurement rules) are recommended.

Table 5 describes some typical scenarios where inter-frequency (IF) measurement and inter-frequency handover (IFHO) are suitable (measurement alternative 52B). To ensure a successful IFHO, in general the cell size should not be too large (i.e., should be small or medium) and the currently utilized cell's serving area should basically be within the CDMA island (e.g., the currently utilized cell should be a center cell) to avoid that signal quality fades out on all frequencies. In some scenarios inter frequency measurement and IFHO may also be suitable for an inner cell and even a border cell, e.g., for scenario 1 in Table 5, f2 (Freq. 2) border cell's coverage is almost within f1 border cell's coverage when f2 load is high and f1 load is low. This is because WCDMA coverage depends on traffic load (e.g., expands with low load and shrinks with high load). For scenario 2 in Table 5, unless the f1 load is much higher than f2 load. f2 inner cell's serving area can also be kept within the f1 island by slightly decreasing the f2 inner cell's coverage. On the other hand, if there is no IF neighbor(s) it is meaningless to have IFHO. For scenario 1 and 2, a f2 cell has IF neighbors (f1 cell). But for scenario 3, scenario 4 and scenario 5, a f1 or hierarchical cell structure (HCS) macro/micro cell may not always have a f2 or HCS micro/macro neighbor(s), and so IFHO is not useful and inter frequency measurement is not needed.

The concept of hierarchical cell structure (HCS), and particularly concepts of micro cells or pico cells or femto cells, is understood with reference to other aspects of cellular radio communications, such as (for example) High Speed Downlink Packet Access (HSDPA) and Enhanced Uplink. See, e.g., 3GPP TS 25.435 V6.2.0 (2005-06), 3rd Generation Partnership Project; Technical Specification Group Radio Access Network; UTRAN I_{ub} Interface User Plane Protocols for Common Transport Channel Data Streams (Release 6), which discusses High Speed Downlink Packet Access (HSDPA) and which is incorporated herein by reference in its entirety.

TABLE 5
Scenarios suitable for IF measurements and handovers

| | | | Frequency | Traffic | |
|---|---|---|---|---|---|
| Scenario | Cell size | Cell position | Layer | load | Deployment |
| 1 | Small or | Any | 2 | High on | F1 macro |
| | medium | | | f2, low on | island, f2 fractional |
| | | | | f1 | co-sited coverage |
| 2 | Small or | Inner or | 2 | Except low | |
| | medium | center | | on f2, high on f1 | |
| 3 | Small or | Center & | 1 | Except low | |
| | medium | having IF | | on f2, high on f1 | |
| | | neighbors | | | |
| 4 | Small | Center or | Micro | any | hierarchical cell |
| | | inner & | layer | | structure (HCS) |
| | | having IF | | | |
| | | neighbors | | | |
| 5 | Small or | Center & | macro | Any | Multi- |
| | medium | having IF | layer | | carriers/hierarchical |
| | | neighbors | | | cell structure |
| | | | | | (HCS) |

Table 6 describes some typical scenarios where IRAT measurement and handover are suitable. There must, of course, be one or more RAT neighbor(s) (e.g. GSM) to perform IRAT HO. Table 6 implies that IFHO is not useful basically when the cell has a large cell size and/or the utilized cell is a border cell, because IFHO likely fails due to the quality of the currently utilized cell becomes too bad before the quality of the cell having another frequency becomes sufficiently good. Therefore only IRAT HO and measurement are required. For scenario 2 of Table 6, IFHO is not recommended for border f2 cell because traffic load is high on both f1 and f2, therefore it might be better to let another system using different RAT (e.g. GSM) to share part of the WCDMA f2 load.

TABLE 6
Scenarios suitable for IRAT measurements and handovers

| | | Cell | Frequency | Traffic | |
|---|---|---|---|---|---|
| Scenario | Cell size | position | Layer | load | Deployment |
| 1 | Large | any | 2 | Except | F1 macro |
| | | | | high on f2, | island, f2 |
| | | | | low on f1 | fractional |
| 2 | Small or | Border | 2 | High on f1 | co-sited |
| | medium | | | and f2 | coverage, |
| 3 | Any | Border | 1 | Any | with RAT |
| 4 | Large | Any | 1 | Any | neighbor(s) |

Table 7 describes some typical scenarios where both IF and IRAT measurement and the corresponding handover are needed. For the scenarios in Table 7 only adopting IFHO may risk a somewhat high dropping rate, but only having IRAT HO may lead to a lot of CDMA traffic leakage to another RAN. Therefore it is more suitable to apply both types of handover (IF and IRAT), which requires the combined measurement.

TABLE 7
Scenarios suitable for combined IF and IRAT measurements and handovers

| | | | Frequency | Traffic | |
|---|---|---|---|---|---|
| Scenario | Cell size | Cell position | Layer | load | Deployment |
| 1 | Large | Any | 2 | High on f2, | F1 macro |
| | | | | low on f1 | island, f2 fractional |
| 2 | Small or | Border | 2 | Low or | co-sited coverage, |
| | medium | | | medium on | with RAT |
| | | | | f1 and f2 | neighbor(s) |
| 3 | Small or | Inner & | 1 | Except low | |
| | medium | having IF | | on f2, high on f1 | |
| | | neighbors | | | |
| 4 | Small | Border & | Micro | Any | hierarchical cell |
| | | having IF | layer | | structure (HCS) |
| | | neighbors | | | |
| 5 | Large | Center & | Macro | Any | Multi- |
| | | having IF | layer | | carriers/hierarchical |
| | | neighbors | | | cell structure |
| 6 | Any | Border or | Macro | Any | (HCS), with RAT |
| | | inner & | layer | | neighbor(s) |
| | | having IF | | | |
| | | neighbors | | | |

The measurement rules for a hierarchical cell structure (HCS) micro cell could also be applied for a hierarchical cell structure (HCS) pico cell. The measurement rules for macro small cell could also be applied for micro and pico cells (non-HCS case).

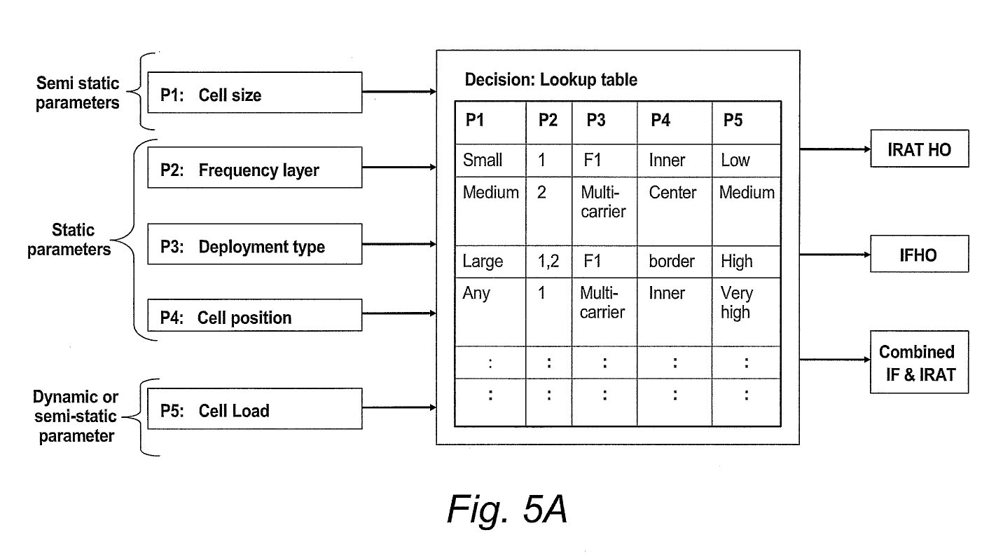

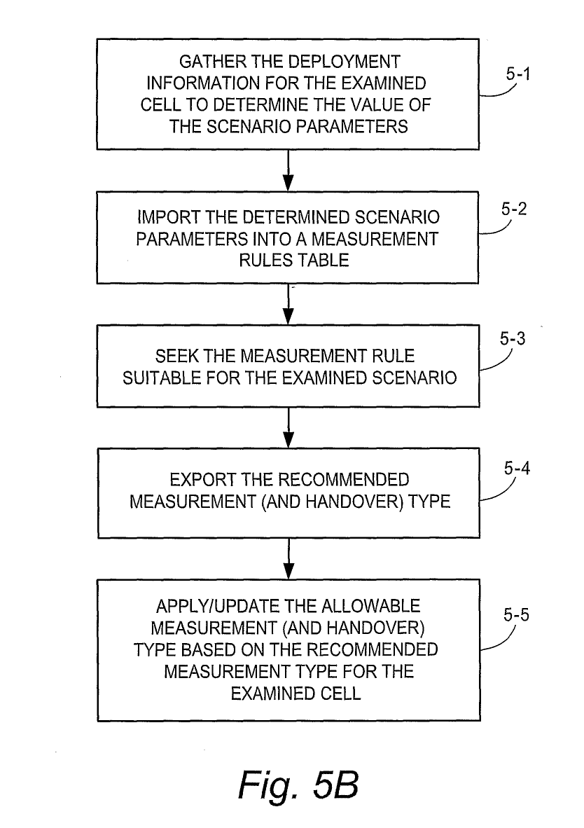

Measurement type selection is the practice of the measurement rules, as shown in FIG. 5A. It is performed on cell basis and includes the following procedures as illustrated in FIG. 5B:
Step 5-1: Gather the deployment information (some of the information may be dedicated for the examined cell, i.e., the currently utilized cell) to determine the value of the scenario parameters.
Step 5-2: Import the determined scenario parameters into a measurement rules table.
Step 5-3: Seek the measurement rule suitable for the examined scenario.
Step 5-4: Export the recommended measurement (and handover) type.
Step 5-5: Apply/update the allowable measurement (and handover) type based on the recommended measurement type for the examined cell.

For users served by the examined cell, if they already start the measurement, the cell measurement type update may lead to that the users change their ongoing measurement type accordingly.

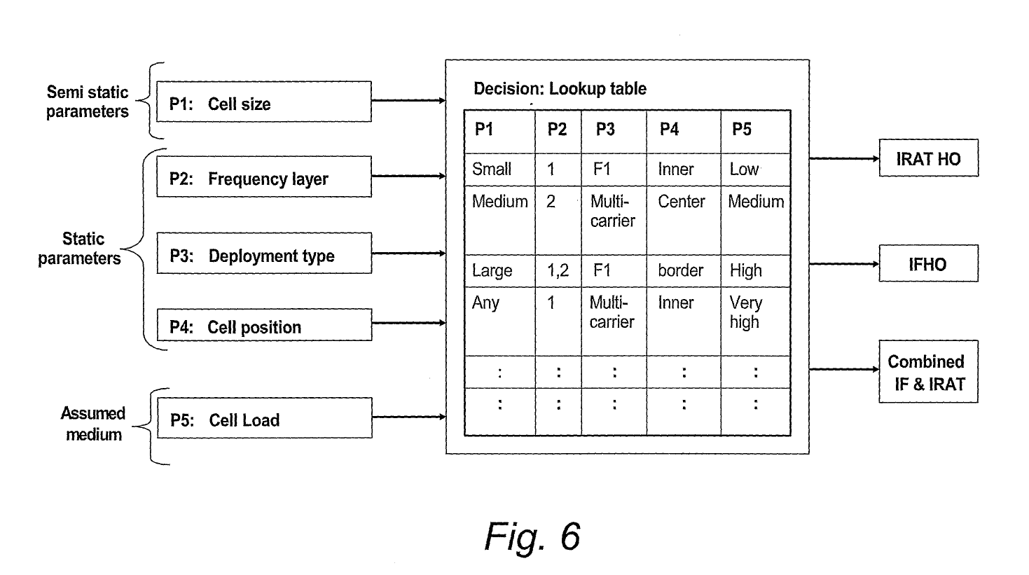

The measurement rules can be simplified by, e.g., assuming one or more scenario parameter(s) to a predefined fixed value(s) regardless of the true value(s). This can be used to set the measurement and handover type as wished. Moreover, this may be beneficial when the scenario parameter(s) (e.g. cell load) has/have large variation and change quickly (avoiding too frequent measurement type update). An example of measurement type selection based on the simplified measurement rules is illustrated in FIG. 6, where the cell load is assumed medium on all frequency layers.

Due to the irregularity of real network one or more scenario parameter(s) may have multiple values. In such case(s) it may be hard to determine the scenario pattern for a cell. For instance, for an irregular cell the cell size may be small in one sector but large in another sector. There are several ways to solve the problem.

An example first way to solve the problem of multiple values for a parameter(s) involves traffic weighted cell size. This approach includes steps such as: dividing a cell into several sectors in a way that all the sectors contain the cell border line; estimating the effective sector size (in terms of the cell size measure (e.g. RSCP) at the cell border belonging to the sector) and traffic load of each sector; and calculating the cell size in accordance, e.g., with Equation 1.

Equation 1:

cell size=f(sector sizeₗ, sector loadₗ, . . . , sector sizeᵢ, sector loadᵢ, . . . ) (1)

One embodiment of the function is the traffic weighted average cell size, as provided by Equation 2:

$$cell size = ( {\sum }_{i = 1}^{N} sector {size}_{i} \times sector {load}_{i} ) / ( {\sum }_{i = 1}^{N} sector {load}_{i} ) \qquad ( 2 )$$

In Equation 2, N is the total number of sector size measurement/estimation samples and sector load measurement/estimation samples. The sector size measurement/estimation could be any of the following:
Sector pattern values (small, medium, large): then cell size is set to the closest cell pattern value (small, medium, large) and directly used as input for measurement type selection.
Actual sector size: then cell size is evaluated according to (2), based on which the cell pattern (small, medium, large) is determined. The cell pattern value is then used for measurement type selection.

The sector load measurement/estimation for Equation 2 could use either uplink (UL) or downlink (DL) load measure, and may be:
UL throughput/number of users per sector, noise rise per sector, ratio of TFC limitation per sector, etc.
DL throughput/number of users per sector, RBS power consumed per sector. etc.

A second way to solve the problem of multiple values for a parameter(s) involves a measurement type switch. That is, a more adaptive solution involves doing an event-triggered measurement type switch on a user basis. UE and/or network measurement reports are used to determine the value of the scenario parameter(s), and the measurement rules are applied for the examined user equipment unit. e.g.:
Suppose a macro multi-carriers deployment, and a UE is served by a center cell with −105 dBm RSCP (obtained from UE's measurement report) to the serving cell, this is corresponding to the medium cell size i.e. scenario 5 in Table 5 for the UE. therefore only inter frequency measurement and IFHO are allowed for this UE:
After some time the RSCP decreases to e.g. −110 dBm, corresponding to scenario 5 in Table 7 (large center cell) for the UE, then both IF and IRAT measurement and the corresponding handover should be allowed for the UE.

Variation in cell load may also lead to measurement type switch.

The present technology adopts the combined measurement (e.g., measurement alternative 52C) only when necessary, therefore decreasing measurement reporting delay, signaling overhead, and processing load.

In some scenarios, by preventing the use of combined measurement but using the compressed mode pattern with the same gap intensity as required for the combined measurement, the individual measurement delay (e.g. IRAT or IF) can be significantly reduced.

Other advantages of the techniques and technology disclosed here are manifest. As a first example advantage, the technology is easy to implement: the measurement rules can be assembled into a table and the measurement type selection and switch functions can be based on a ‘Look Up Table’.

Another example advantage is backward compatibility. By setting the scenario parameter(s) to a predefined value(s), the allowable measurement and handover type can be set as desired, as it is implemented in present communication systems.

Thus, as explained above, a deployment scenario is characterized by a set of scenario parameters. A set of measurement type selection rules are formulated and/or exist based on the scenario parameters. A process that is described for a cell level measurement type update can be based on “look up measurement rule table”. A process is described for user level measurement type update based on UE and/or network measurement reports and “look up measurement rule table”. Further, methods are described to evaluate the scenario parameter in case the scenario parameter has multiple values.

The technology described herein facilitates performance of the right type of handover and measurement selection, based on deployment parameters that are germane for determining a suitable HO. For example, in one scenario the technology considers that compressed mode (CPM) is triggered due to the fact that a UE is going to move out of WCDMA coverage on one carrier. The technology described herein endeavors to predict whether the UE will be out of WCDMA coverage on all the carriers, and therefore predicts whether it is too dangerous to do an inter-frequency handover (WHO) even the WCDMA quality (on other carriers) is still good when CPM is triggered.

In some of its aspects, the technology described herein is cell based and can be done essentially anytime purely at a system side without the assistance of the user equipment unit. Moreover, the signaling cost is limited since most deployment parameters are static and can be estimated I determined in prior. When the UE triggers a CPM, the user equipment unit simply performs the type of measurement and HO that are already determined by the system. This means the measurement type selection does not introduce additional delay.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. It is to be understood that the invention is not to be limited to the disclosed embodiment, but on the contrary, is intended to cover various modifications and equivalent arrangements.

What is claimed is:

1. A node of a radio access network which provides a measurement request for a user equipment unit served by a currently utilized cell to measure on signal(s) transmitted from other cell(s) for evaluating handover potential, the node being arranged to use a deployment parameter to select between three measurement alternatives for the measurement request, the three measurement alternatives being: (1) performing only a first type of measurement(s); (2) performing only a second type of measurement(s); and (3) simultaneously performing both the first type and the second type of measurement(s).

2. The apparatus of claim 1, wherein the three measurement alternatives are: (1) performing only an inter-frequency measurement(s); (2) performing only an inter-radio access technology measurement(s); and (3) simultaneously performing both inter-frequency measurement(s) and inter-radio access technology measurement(s).

3. The apparatus of claim 1, wherein the deployment parameter comprises at least one of the following: cell topology, cell size, cell position, traffic load and frequency layer.

4. The apparatus of claim 3, wherein the node is arranged to use a set of deployment parameters to select between the three measurement alternatives for the measurement request, and wherein the set of deployment parameters comprise cell topology, cell size, cell position, traffic load and frequency layer.

5. The apparatus of claim 3, wherein the node is arranged to use a set of deployment parameters to select between the three measurement alternatives for the measurement request, and wherein for simplification at least one of the deployment parameters of the set has a predefined value regardless of its true value.

6. The apparatus of claim 1, wherein the node is arranged to use a set of deployment parameters to select between the three measurement alternatives for the measurement request, and wherein the node is arranged to use the set of deployment parameters to classify a particular scenario, and is further arranged to select between the three measurement alternatives in accordance with the particular scenario.

7. A radio access network comprising:
a network node;
a user equipment unit served by a currently utilized cell;
wherein the node is arranged to provide a measurement request to the user equipment unit to request the user equipment unit to measure on signal(s) transmitted from other cell(s) for evaluating handover potential, the node being arranged to use a deployment parameter to select between three measurement alternatives for the measurement request, the three measurement alternatives being: (1) performing only a first type of measurement(s); (2) performing only a second type of measurement(s): and (3) simultaneously performing both the first type and the second type of measurement(s).

8. The apparatus of claim 7, wherein the three measurement alternatives are: (1) performing only an inter-frequency measurement(s); (2) performing only an inter-radio access technology measurement(s); and (3) simultaneously performing both inter-frequency measurement(s) and inter-radio access technology measurement(s).

9. The apparatus of claim 7, wherein the deployment parameter comprises at least one of the following: cell topology, cell size, cell position, traffic load and frequency layer.

10. The apparatus of claim 9, wherein the node is arranged to use a set of deployment parameters to select between three measurement alternatives for the measurement request, and wherein the set of deployment parameters comprises cell topology, cell size, cell position, traffic load and frequency layer.

11. The apparatus of claim 9, wherein the node is arranged to use a set of
deployment parameters to select between the three measurement alternatives for the measurement request, and wherein for simplification at least one of the deployment parameters of the set has a predefined value regardless of its true value.

12. The apparatus of claim 7, wherein the node is arranged to use a set of deployment parameters to select between three measurement alternatives for the measurement request, wherein the node is arranged to use the set of deployment parameters to classify a particular scenario, and is further arranged to select between the three measurement alternatives in accordance with the particular scenario.

13. A method of operating a radio access network comprising a network node and a user equipment unit served by a currently utilized cell, the method comprising:
the node providing a measurement request for the user equipment unit to measure on signal(s) transmitted from other cell(s) for evaluating handover potential;
the node using a deployment parameter for selecting between three measurement alternatives for the measurement request, the three measurement alternatives being: (1) performing only a first type of measurement(s); (2) performing only a second type of measurement(s); and (3) simultaneously performing both the first type and the second type of measurement(s).

14. The method of claim 13, wherein the three measurement alternatives are: (1) performing only an inter-frequency measurement(s); (2) performing only an inter-radio access technology measurement(s); and (3) simultaneously performing both inter-frequency measurement(s) and inter-radio access technology measurement(s).

15. The method of claim 13, wherein the deployment parameter comprises at least one of the following: cell topology, cell size, cell position, traffic load and frequency layer.

16. The method of claim 15, further comprising the node using a set of deployment parameters for selecting between the three measurement alternatives for the measurement request, wherein the set of deployment parameters comprises cell topology, cell size, cell position, traffic load and frequency layer.

17. The method of claim 15, further comprising:
the node using a set of deployment parameters for selecting between the three measurement alternatives for the measurement request: and
for simplification, providing at least one of the deployment parameters of the set with a predefined value regardless of its true value.

18. The method of claim 13, further comprising:
the node using a set of deployment parameters for selecting between the three measurement alternatives for the measurement request,
the node using the set of deployment parameters for classifying a particular scenario:
the node selecting between the three measurement alternatives in accordance with the particular scenario.

19. A node of a radio access network which provides a measurement request for a user equipment unit served by a currently utilized cell to measure on signal(s) transmitted from other cell(s) for evaluating handover potential, the node being arranged to use a deployment parameter to specify in the measurement request a type of cell upon which to measure, the deployment parameter comprising at least one of the following: cell topology, cell size, cell position, traffic load and frequency layer.

20. The apparatus of claim 19, wherein the node is arranged to use a set of deployment parameters to specify a type of cell upon which to measure, and wherein the set of deployment parameters comprise cell topology, cell size, cell position, traffic load and frequency layer.

21. The apparatus of claim 19, wherein the type of cell upon which to measure is specified to be either: (1) only a cell(s) comprising a different frequency than the currently utilized cell; (2) only a cell(s) of a different radio access technology than the currently utilized cell; and (3) both cell(s) comprising a different frequency than the currently utilized cell and cell(s) of a different radio access technology than the currently utilized cell.

22. A radio access network comprising:
a network node;
a user equipment unit served by a currently utilized cell;
wherein the node is arranged to provide a measurement request to the user equipment unit to request the user equipment unit to measure on signal(s) transmitted from other cell(s) for evaluating handover potential, the node being arranged to use a deployment parameter to specify in the measurement request a type of cell upon which to measure, the deployment parameter comprising at least one of the following: cell topology, cell size, cell position, traffic load and frequency layer.

23. The apparatus of claim 22, wherein the node is arranged to use a set of deployment parameters to specify a type of cell upon which to measure, and wherein the set of deployment parameters comprise cell topology, cell size, cell position, traffic load and frequency layer.

24. The apparatus of claim 22, wherein the type of cell upon which to measure is specified to be either: (1) only a cell(s) comprising a different frequency than the currently utilized cell; (2) only a cell(s) of a different radio access technology than the currently utilized cell: and (3) both cell(s) comprising a different frequency than the currently utilized cell and cell(s) of a different radio access technology than the currently utilized cell.

25. A method of operating a radio access network comprising a network node and a user equipment unit served by a currently utilized cell, the method comprising:
the node providing a measurement request for the user equipment unit to measure on signal(s) transmitted from other cell(s) for evaluating handover potential;
the node using a deployment parameter to specify in the measurement request a type of cell upon which to measure, the deployment parameter comprising at least one of the following: cell topology, cell size, cell position, traffic load and frequency layer.

26. The method of claim 25, further comprising the node using a set of deployment parameters to specify a type of cell upon which to measure, and wherein the set of deployment parameters comprises cell topology, cell size, cell position, traffic load and frequency layer.

27. The method of claim 25, wherein the type of cell upon which to measure is specified to be either: (1) only a cell(s) comprising a different frequency than the currently utilized cell; (2) only a cell(s) of a different radio access technology than the currently utilized cell; and (3) both cell(s) comprising a different frequency than the currently utilized cell and cell(s) of a different radio access technology than the currently utilized cell.
